(19) United States
(12) Patent Application Publication
(10) Pub. No.: US 2004/0266364 A1
(43) Pub. Date: Dec. 30, 2004

(54) Method and apparatus for customization of a user interface

(76) Inventors: Bach L. Nguyen, Plantation, FL (US); Julio C. Castaneda, Coral Springs, FL (US); Scott F. Musil, Corals Springs, FL (US); Adema Verne, Pompano Beach, FL (US); Steve M. Joss, Pompano Beach, FL (US); David H. Karl, Ft. Lauderdale, FL (US)

Correspondence Address: Larry G. Brown, Motorola, Inc., Law Department, 8000 West Sunrise Boulevard, Fort Lauderdale, FL, 33322, US

(21) Appl. No.: 10/608,322

(22) Filed: Jun. 27, 2003

(51) Int. Cl. H04M 1/00

(52) U.S. Cl. 455/90.3; 455/550.1

(57) ABSTRACT

A method (200) of assembling a mobile communications unit (120). The method (200) includes the steps of producing (212) a universal base component (118) at an assembly facility (110) and shipping (214) the universal base component (118) to a separate facility in which the separate facility contains a selection of user interfaces (122). The user interfaces (122) are used to initiate a feature in the mobile communications unit (120), and the selection of user interfaces (122) includes user interfaces (122) associated with different customers (114). The method (200) also includes selecting (216) a user interface (122) from the selection of user interfaces (122) and incorporating (218) the selected user interface (122) into the universal base component (118) at the separate facility.

### CROSS REFERENCE TO RELATED APPLICATIONS

(Not Applicable)

### BACKGROUND

1. Technical Field

This invention relates in general to mobile communications units and more particularly, to components for such units and their assembly.

2. Description of the Related Art

Many mobile communications units support dual communication modes. In particular, a dual communication mode mobile unit can support both cellular telephone service and dispatch service. Most mobile units that support both of these communication modes include a push-to-talk (PTT) button for initiating a dispatch communication. For example, to initiate the process for contacting a person through this mode, a user may locate a person in a menu and simply press the PTT button on the mobile unit to contact the person; no dialing or any other steps are required.

Because of their popularity, several different communications services buy these dual communication mode mobile units from manufacturers and sell them to the public. A company that sells these phones to the public may wish to have, for example, its trademarks or other insignia placed on the mobile unit to notify the user of the mobile unit that the company is providing the communications service. As such, the manufacturer of the mobile units may be burdened with assembling a wide variety of these devices, each emblazoned with a particular designation associated with the company that eventually purchases the mobile unit from the manufacturer. As an example, a company that buys these mobile units may direct the manufacturer to place that company's trademark(s) on the PTT buttons.

When assembling these dual communications mobile units, the PTT button is typically positioned against a portion of the mobile unit, and a snap is used to secure the PTT button in place. The snap, normally a plastic piece that fits around the outer edges and a portion of the center of the PTT button, is designed to secure permanently the PTT button to the mobile unit. Accordingly, once the PTT button is attached to the mobile unit, the only way to remove or replace the PTT button is to disassemble major components of the mobile unit.

As a result, when a mobile unit is shipped to a distribution center, the PTT button is already solidly assembled into the unit, which makes it extremely difficult to replace the PTT button. If a company that is buying mobile units that contain a PTT button requests the manufacturer of the devices to place that company's trademark on the PTT button, two rather inefficient options exist: (1) the manufacturer can assemble a different mobile unit model for each company that desires to incorporate such a designation into the PTT button; or (2) the PTT button and the components that are used to secure it to the mobile unit can be disassembled at the distribution center, or some other location further along the distribution chain, and a new PTT button containing the trademark can be reassembled into the mobile unit.

Either arrangement is unsatisfactory. Concerning option 1, it is expensive to assemble and keep in inventory numerous models. Moreover, with respect to option 2, additional labor expense may be added into the cost of the mobile unit because the PTT button and related components must be disassembled and subsequently reassembled at the distribution center. Even worse, the quality of the assembly of the PTT button, once it is subjected to this disassembly and reassembly process, may be compromised. Thus, what is needed in that art is a method that enables customization of such a user interface. In addition, the PTT button itself must be constructed in a manner that permits easy assembly or even disassembly without affecting its integrity.

### SUMMARY OF THE INVENTION

The present invention concerns a user interface for initiating a feature in a mobile communications unit. The user interface includes a flexible cover having at least one contact surface in which a user engages the contact surface to initiate the feature in the mobile communications unit and having at least one extension extending away from the flexible cover. The user interface also includes a flexible sheet in which the flexible cover and the flexible sheet are in a first position when undisturbed and a second position when being manipulated for incorporation into the mobile communications unit. The flexible sheet at least partially directs the flexible cover to return to the first position after the flexible cover and the flexible sheet are manipulated into the second position.

In one arrangement, the extensions extending away from the flexible cover can detachably engage at least one slot mounted on the mobile communications unit when the flexible cover is in the first position. Additionally, the flexible sheet can include at least one extension extending away from the flexible sheet in which the extensions of the flexible sheet correspond to the extensions of the flexible cover. The flexible cover can be constructed of, for example, rubber and plastic. As another example, the flexible sheet can be constructed of metal.

In another arrangement, the user interface can include at least one indicator in which the indicator can be disposed within and visible from the contact surface. The indicator can illuminate to inform the user of a status of a network connection or the receipt of an incoming communications signal. In yet another arrangement, the flexible cover can include a designation associated with a customer.

The present invention also concerns a method of assembling a mobile communications unit. The method can include the steps of producing a universal base component at an assembly facility, shipping the universal base component to a separate facility in which the separate facility contains a selection of user interfaces, and the user interfaces are used to initiate a feature in the mobile communications unit. The selection of user interfaces includes user interfaces associated with different customers. The method also includes the steps of selecting a user interface from the selection of user interfaces and incorporating the selected user interface into the universal base component at the separate facility.

In one arrangement, the user interface can include a flexible cover and a flexible sheet in which the flexible cover can include at least one extension extending away from the flexible cover. Further, the flexible sheet can also include at least one corresponding extension extending away from the flexible sheet. The incorporating step can include the step of manipulating the user interface to permit the extensions of the flexible cover and the extensions of the flexible sheet to engage at least one slot positioned on the universal base component.

In yet another arrangement of the invention, the incorporating step can further include the step of positioning the flexible sheet adjacent to the flexible cover. As such, the flexible sheet can at least partially direct the flexible cover in a manner that permits the extensions of the flexible cover to engage the slots. Additionally, each of the user interfaces can include a designation identifying the user interface as being associated with a customer.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a distribution chain for distributing telecommunications equipment in accordance with the inventive arrangements.

FIG. 2 illustrates an example of a method of distributing telecommunications equipment along the distribution chain of FIG. 1 in accordance with the inventive arrangements.

FIG. 3 illustrates a universal base component of a mobile telecommunications unit in accordance with the inventive arrangements.

FIG. 4 illustrates an example of a user interface that may be incorporated into a mobile telecommunications unit in accordance with the inventive arrangements.

FIG. 5 illustrates the user interface of FIG. 4 at a different viewing angle and in a first position in accordance with the inventive arrangements.

FIG. 6 illustrates the user interface of FIG. 4 containing a designation in accordance with the inventive arrangements.

FIG. 7 illustrates the user interface of FIG. 4 in a second position in accordance with the inventive arrangements.

FIG. 8 illustrates the user interface of FIG. 4 assembled into the universal base component of FIG. 3 in accordance with the inventive arrangements.

FIG. 9 illustrates an example of an assembled mobile telecommunications unit in accordance with the inventive arrangements.

FIG. 10 illustrates a user interface that includes an indicator mounted in a user interface of a mobile telecommunications unit and driven by an indicator driver circuit in accordance with the inventive arrangements.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

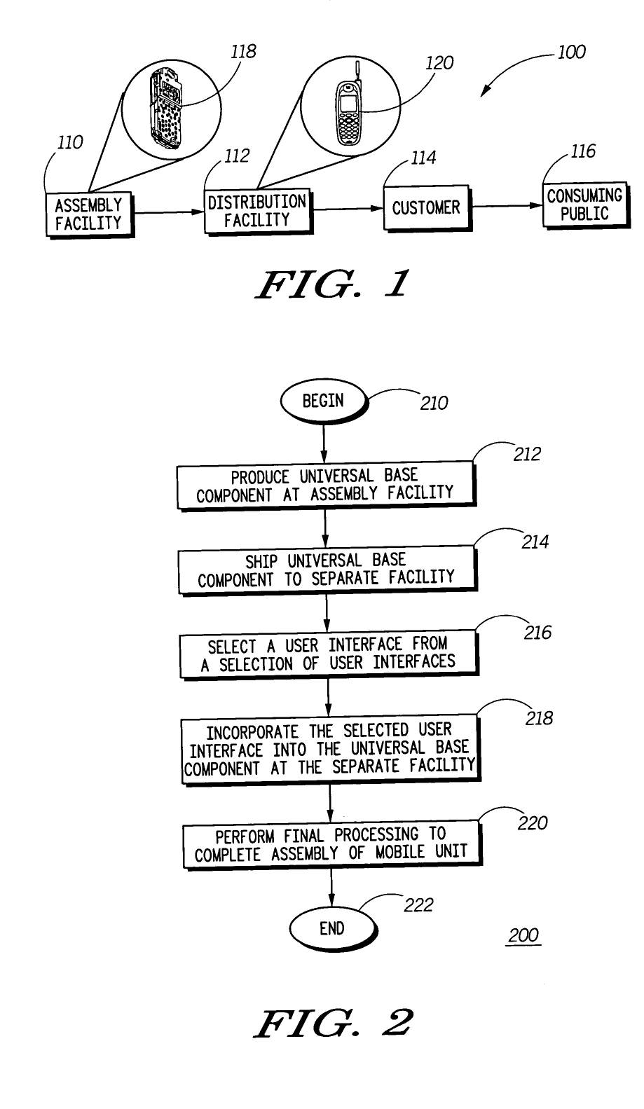

Referring now to FIG. 1, a distribution chain 100 in accordance with the inventive arrangements is shown. The distribution chain 100 can include one or more manufacturing or assembly facilities 110, one or more distribution facilities 112, one or more customers 114 and the consuming public 116. In one arrangement, the assembly facility 110 can manufacture telecommunications equipment such as a universal base component 118 for mobile telecommunications units and can ship these universal base components 118 to the distribution facility 112.

The distribution facility 112 can receive the universal base components 118 and can select other elements or structure to incorporate into the universal base components 118 for purposes of producing a mobile telecommunications unit 120 (mobile unit 120). As a result, at least a portion of the overall assembly of the mobile unit 120 can occur at the distribution facility 112. A mobile telecommunications unit 120 can be any mobile device that can provide one or more communication modes, such as a dual communications mode mobile device that supports both cellular telephone service and dispatch service.

Subsequently, the distribution facility 112 can sell the mobile units 120 to a customer 114. As an example and without limitation, the customer 114 can be a communications network service provider. The customer 114 can then sell the mobile units 120 to the consuming public 116.

It is understood, however, that the invention is not limited to this particular example. Specifically, the distribution chain 100 can include a grater number of elements than those that are illustrated or even a fewer number of elements. In addition, the products in commerce in the distribution chain 100 are in no way limited to mobile telecommunications units, as the assembly facility 110 can manufacture and place into distribution any other suitable device.

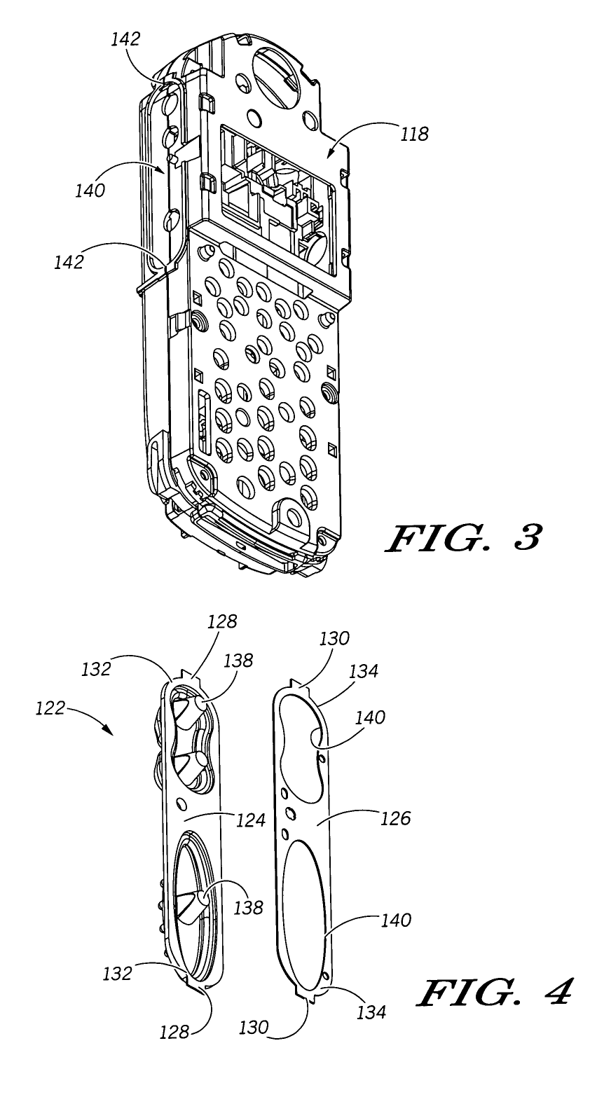

Referring to FIG. 2, a method 200 for distributing telecommunications equipment along the distribution chain 100 of FIG. 1 is shown. To describe the method 200 of FIG. 2, reference will be made to elements described in FIGS. 1 and 3-9. The method 200 can begin at step 210. At step 212, a universal base component can be produced at an assembly facility, similar to the assembly facility 110. Referring to FIG. 3, an example of a universal base component 118, as first mentioned in FIG. 1, is shown. In this example, the universal base component 118 can be a portion of a mobile unit 120 (also see FIG. 1).

It is understood, however, that the invention is not limited to the particular universal base component 118 shown in FIG. 3. Specifically, the term “universal base component,” for purposes of the invention, can mean any common component or common set of assembled components that can be manufactured for any suitable number of separate entities for the eventual production of a final product for one or more of the separate entities.

Referring back to FIGS. 1 and 2, at step 214, the universal base component 118 can be shipped from the assembly facility 110 to a separate facility. As an example, the separate facility can be the distribution facility 112 of FIG. 1; however, the invention is not so limited, as the separate facility can be any location capable of receiving the universal base component 118 and further processing the universal base component 118. Nevertheless, when describing the remaining steps of FIG. 2 to demonstrate the inventive arrangements, reference will be made to the distribution facility 112 of FIG. 1.

The distribution facility 112 may or may not be affiliated with the assembly facility 110. In either arrangement, the distribution facility 112 can contain a selection of user interfaces in which each user interface can be associated or identified with a particular customer 114. At step 216, a user interface can be selected from a selection of user interfaces. Referring to FIG. 4, an example of a user interface 122 in accordance with the inventive arrangements is shown. In this example, the user interface 122 can be a PTT button for use in a dual mode mobile telecommunications unit that supports dispatch service. It must be noted, however, that the invention is not limited to this particular example, as the user interface 122 can be any suitable structure for enabling a user to perform a function or operate a feature associated with a mobile telecommunications unit or any other suitable device.

The user interface 122 of FIG. 4 can include a flexible cover 124 and a flexible sheet 126. In one arrangement, the flexible sheet 126 can be made of a material that is at least slightly more rigid than the material of which the flexible cover 124 is constructed. As such, the flexible sheet 126, in certain circumstances, can at least partially direct or guide the flexible cover 124 back to an original position when the flexible sheet 126 and the flexible cover 124 are manipulated, a process that will be described later.

As an example, the flexible cover 124 can be constructed of rubber or plastic, and the flexible sheet 126 can be constructed of metal, such as aluminum, steel or any suitable alloy. Of course, the flexible cover 124 and the flexible sheet 126 can be constructed of other suitable materials. In addition, the flexible cover 124 can be made of the same material of which the flexible sheet 126 is made; the flexible cover 124 can also be constructed of a material that is more rigid than the material used to build the flexible sheet 126.

In one embodiment, the flexible cover 124 can include one or more extensions 128 extending away from the flexible cover 124. Similarly, the flexible sheet 126 can include one or more extensions 130 extending away from the flexible sheet 126. The extensions 128, 130 can be used to engage a portion of, for example, the universal base component 118 of FIG. 3, a process which will be described below. Although FIG. 4 illustrates the extensions 128 as being mounted on ends 132 of the flexible cover 124 and on ends 134 of the flexible sheet 126, those of skill in the art will appreciate that the extensions 128, 130 may be positioned at other suitable locations on the flexible cover 124 and the flexible sheet 126, respectively.

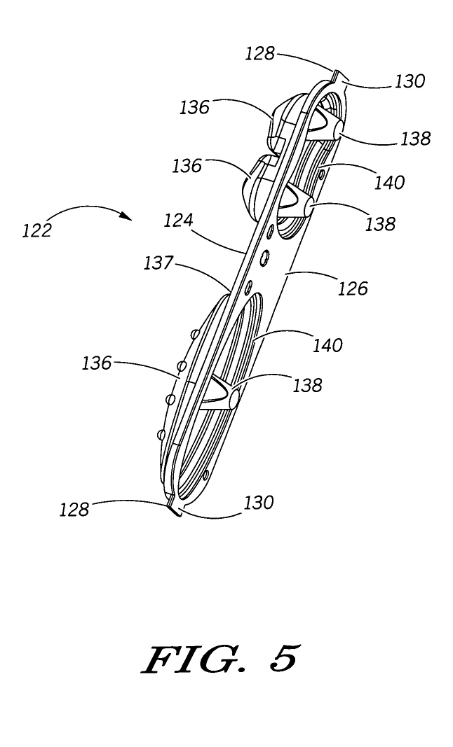

Referring to FIG. 5, the flexible sheet 126 is shown positioned against or adjacent to the flexible cover 124. In one arrangement, the extensions 130 of the flexible sheet 126 can also be positioned against the extensions 128 of the flexible cover 124. As such, the extensions 130 of the flexible sheet 126 can correspond to the extensions 128 of the flexible cover 124.

The flexible cover 124 may also include one or more contact surfaces 136, which can be used to initiate a feature in the mobile unit 120 (see FIG. 1). For example, the contact surfaces 136 can be used to contact a person through dispatch mode, if such a service is supported by the mobile unit 120. As another example, the contact surfaces 136 can be used to control the volume of any speakers embedded within the mobile unit 120. As an example, the contact surface 136 can be raised projections that can extend above a surface 137 of the flexible cover 124, although any other suitable structure can serve as the contact surfaces 136.

Focusing on the user interface 122 of FIG. 5, the single large contact surface 136 located near the bottom of the flexible cover 124 can be used to initiate a dispatch mode contact. Also, the two contact surfaces 136 near the top of the flexible cover 124 can be used to control the volume of a speaker used to broadcast the communications signals received by the mobile unit 120. Of course, it is understood that the invention is not limited in this regard, as the contact surfaces 136 can be used to initiate any other feature of the mobile unit 120.

Referring to FIGS. 4 and 5, the flexible cover 124 can further include one or more protrusions 138 attached to corresponding contact surfaces 136. The protrusions 138 can translate the force applied to the contact surfaces 136 by a user to the appropriate circuitry in the mobile unit 120 (see FIG. 1) for purposes of producing the desired effect. Moreover, the flexible sheet 126 can include one or more apertures 140 for permitting the protrusions 138 to pass through the flexible sheet 126.

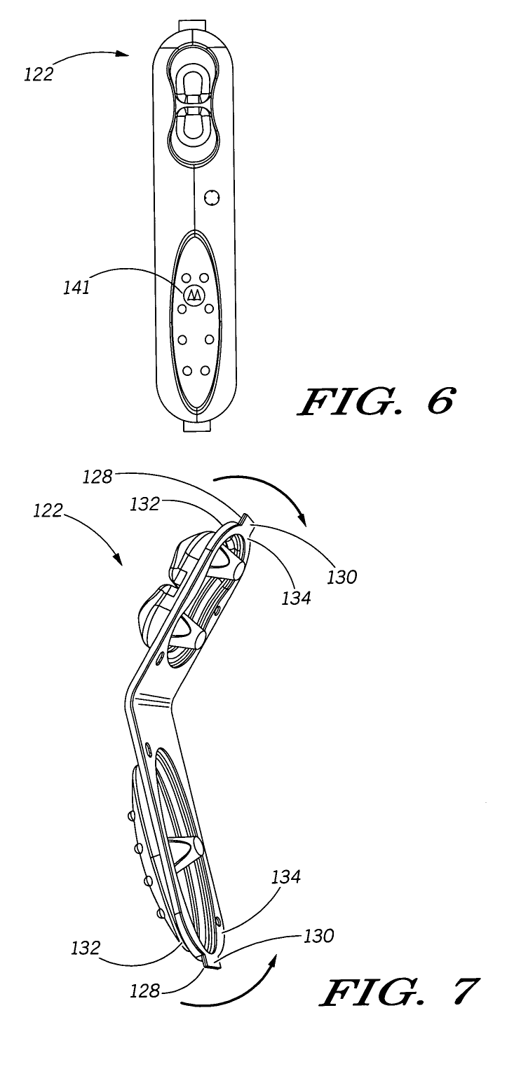

As shown in FIG. 6, the user interface 122 can also include a designation 141. The designation 141 can be associated with, for example, the entity that performs the assembly of the mobile unit 120 (see FIG. 1) or the customer 114 (also see FIG. 1). It must be noted, however, that the designation 141 can be associated with any other suitable entity. As an example and without limitation, the designation 141 can be a trademark or any other identifier that can be used to identify the source of the goods or services associated with the mobile unit 120. In this arrangement, the distribution facility 112 of FIG. 1, or any other suitable facility, can store many types of user interfaces 122, each having a particular designation 141.

Referring back to FIG. 2, after the user interface is selected (at step 216), the selected user interface can be incorporated into the universal base component at the separate facility, as shown at step 218. This process will be described in relation to FIGS. 5 and 7-8. In FIG. 5, the user interface 122 is shown in a first position. This first position can be defined as the state of the user interface 122 when the user interface 122 is undisturbed or at least substantially undisturbed (this first position can include the term “undisturbed” and the phrase “substantially undisturbed”). In this first position, the flexible sheet 126 can be positioned against the flexible cover 124 such that the extensions 130 of the flexible sheet 126 at least substantially correspond to the extensions 128 of the flexible cover 124.

The user interface 122 can then be manipulated into a second position for purposes of incorporating the user interface 122 into the mobile unit 120. An example of the user interface 122 in a second position is shown in FIG. 7. Here, a force may be applied to the ends 132 of the flexible cover 124, which can also be translated to the ends 134 of the flexible sheet 126. In response, the ends 132 and the ends 134 can swing towards one another, respectively. This process can temporarily reduce the overall length of the user interface 122. The force may be applied by a human or a machine.

Referring back to FIG. 3, the universal base component 118 can include a channel 140 for receiving the user interface 122 (not shown in FIG. 3). Referring to FIGS. 3 and 7, the channel 140 can include one or more slots 142 for receiving the extensions 128 of the flexible cover 124 and the extensions 130 of the flexible sheet 126. In one arrangement, the shape of the channel 140 can correspond to the shape of the user interface 122 to ensure a snug fit. Nevertheless, the invention is not limited to this particular arrangement, as the shape of the channel 140 can assume any other suitable configuration.

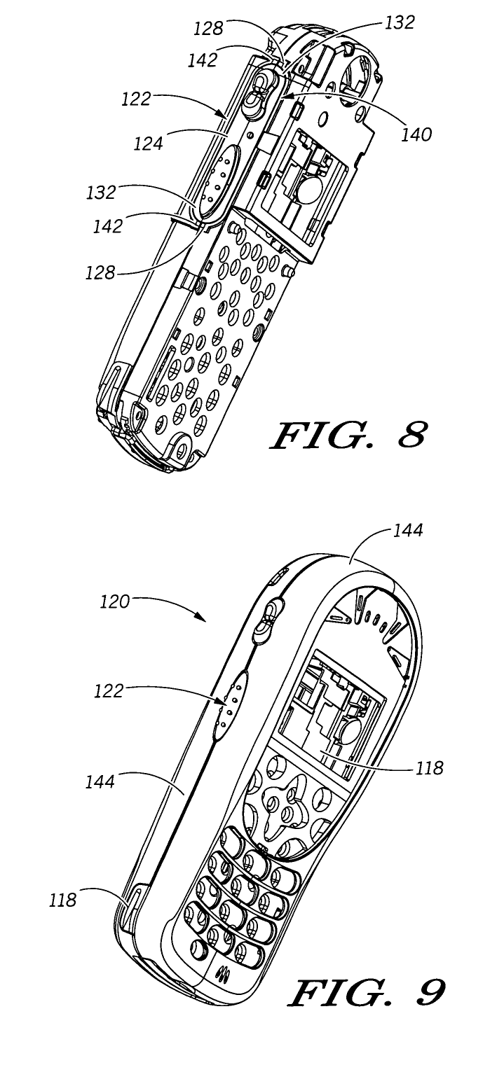

Referring now to FIGS. 3, 7 and 8, once the user interface 122 is placed in the second position (see FIG. 7), the user interface 122 can be inserted into the channel 140. As the user interface 122 is placed in the channel 140 or following such placement, the force that has caused the ends 132, 134 to move towards one another (respectively) can be removed. When the force is removed, the flexible sheet 126 can at least partially direct the flexible cover 124 to return to the first position. That is, the flexible sheet 126 can act as a supplement to the flexible cover's 124 own inclination to return to its original position. As a result, the ends 132, 134 can move towards the slots 142 of the channel 140, which can cause the extensions 128, 130 to slide into and engage the slots 142. The final engagement of the user interface 122 with the channel 140 is illustrated in FIG. 8.

The user interface 122, in view of its design described above, can also be easily replaced, if so desired. For example, referring again to FIGS. 3, 7 and 8, if the flexible cover 124 is damaged, the user interface 122 can be removed by first forcing the ends 132 of the flexible cover 124 towards one another and away from the slots 142. This force can also be translated to the flexible sheet 126, which can cause the ends 134 to move towards each other. Next, the flexible cover 124 and the flexible sheet 126 can be removed from the channel 140. The damaged flexible cover 124 can be replaced, and the new flexible cover 124 along with the flexible sheet 126 can be mounted in the channel 140 as previously described.

The flexible cover 124 may also be replaced for reasons other than the flexible cover 124 sustaining damage. Because virtually no disassembly is required to replace the user interface 122 and because of the guidance provided by the flexible sheet 126, the overall integrity of the assembly of the user interface 122 is not compromised during its replacement, or even its initial incorporation into the mobile unit 120.

In accordance with the inventive arrangements and referring to FIGS. 1 and 6, the user interface 122 can be incorporated into the mobile unit 120 at a facility separate from the assembly facility 110, such as the distribution facility 112. In addition, the distribution facility 112 can store many types of user interfaces 122, each containing a particular designation 141 associated with, for example, the assembly facility 110, the customer 114, the distribution facility 112 or any other suitable entity. As a result, the assembly facility 110 can limit its assembly to that of, for example, the universal base component 118, an item common to all the customers 114 of the mobile units 120. This process can eliminate the requirement that the assembly facility 110 produce and keep in inventory different types of models of mobile units 120.

In particular, the design of the user interface 122 supports the implementation of the distribution chain 100 as illustrated herein. That is, a specific user interface 122 stored at the distribution facility 112 can be selected from a variety of user interfaces 122 and can be easily incorporated into a universal base component 118 at the distribution facility 112 in view of its construction. In addition, in view of its design, the user interface 122 is easily replaceable at the distribution facility 112 or any other suitable entity without any adverse effects.

Returning to FIG. 2, at step 220, any final processing to complete the assembly of the mobile unit can be performed. This final processing can be performed at the separate facility or even another facility. For example, the final processing can be carried out at the distribution facility 112 of FIG. 1. In one arrangement, the final processing can be any processes or assembly necessary to place the mobile unit 120 (see FIG. 1) in a condition ready for shipping to a customer 114 (also see FIG. 1). As an example and referring to FIG. 9, a pair of covers 144 can be attached to the universal base component 118 (several items, such as a display, have been omitted from FIG. 9 to illustrate the engagement of the universal base component 118 with the covers 144). These covers 144 can cover at least a portion of the user interface 122. It is understood, however, that the invention is not limited to this example, as any other suitable steps can be performed during this final processing stage. Finally, at step 222 of FIG. 2, the method 200 can end.

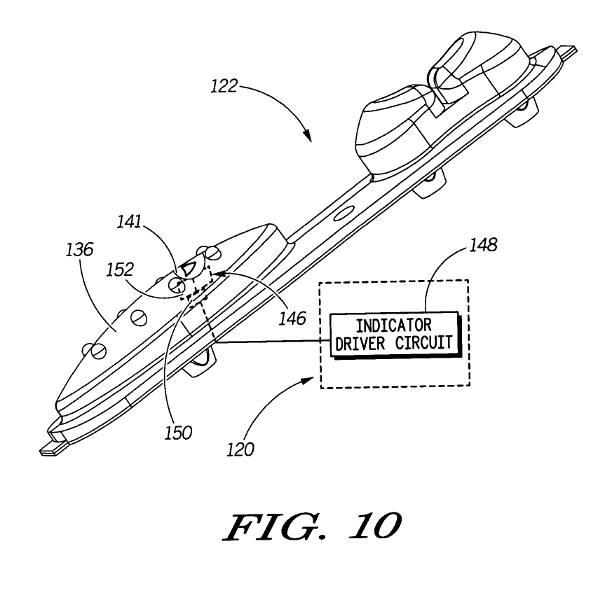

Referring to FIG. 10, another example of a user interface 122 in accordance with the inventive arrangements is shown. For purposes of clarity, the user interface 122 is shown separate from the mobile unit 120 (represented by a dashed outline). In this embodiment, the user interface 122 can include one or more indicators 146 (also represented by a dashed outline). In one arrangement, the indicator 146 can be disposed within and visible from at least one of the contact surfaces 136. In another arrangement, the indicator 146 can inform a user of the status of a network connection, such as the status of the network connection with the mobile unit 120, or it can inform the user of the receipt of an incoming communications signal.

An indicator driver circuit 148 inside the mobile unit 120 can selectively activate the indicator 146 based on certain circumstances, some of which will be presented below. A coupling 150 (also represented by the dashed outline) can detachably couple the indicator 146 to the indicator driver circuit 148, which can facilitate the removability of the user interface 122.

As an example, the indicator 146 can be one or more LEDs 152, and the indicator driver circuit 148 can be an LED driver circuit. As shown in FIG. 10, the LEDs 152 can be built into the contact surface 136 near the bottom of the flexible cover 124. In another arrangement, the LEDs 152 can illuminate the designation 141 on the contact surface 136 when the LEDs 152 are activated; however, the invention is not so limited, as the LEDs 152 can be mounted at other suitable locations on the user interface 122 or even other locations on the mobile unit 120.

In one embodiment, the user interface 122 can include two LEDs 152: one green LED 152 and one red LED 152. As an example, the green LED 152 and the red LED 152 can be illuminated to inform the user of the status of the network connection. Specifically, the green LED 152 can be intermittently illuminated thereby indicating to the user that the network connection is in working order. In contrast, the red LED 152 can be illuminated if there is no connection or if there is an impediment to the operation of the mobile unit 120. In addition, either the green LED 152 or the red LED 152 can be illuminated when the mobile unit 120 receives an incoming communications signal.

It is understood that the invention is not limited to the example described above. For example, the indicator 146 can be any suitable device for informing the user of the mobile unit 120 of any condition that may be important to the user. Moreover, if the indicator 146 is one or more LEDs 152, the invention can include any suitable number of LEDs 152, each of which can illuminate as any suitable color of light.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A user interface for initiating a feature in a mobile communications unit, comprising:
a flexible cover having at least one contact surface, wherein a user engages said contact surface to initiate the feature in the mobile communications unit, and having at least one extension extending away from said flexible cover; and
a flexible sheet, wherein said flexible cover and said flexible sheet are in a first position when undisturbed and a second position when being manipulated for incorporation into the mobile communications unit, wherein said flexible sheet at least partially directs said flexible cover to return to said first position after said flexible cover and said flexible sheet are manipulated into said second position.

2. The user interface according to claim 1, wherein said extensions extending away from said flexible cover detachably engage at least one slot mounted on the mobile communications unit when said flexible cover is in said first position.

3. The user interface according to claim 1, wherein said flexible sheet includes at least one extension extending away from said flexible sheet, said extensions of said flexible sheet corresponding to said extensions of said flexible cover.

4. The user interface according to claim 1, wherein said flexible cover is constructed of a material selected from the group consisting of rubber and plastic.

5. The user interface according to claim 1, wherein said flexible sheet is constructed of metal.

6. The user interface according to claim 1, further comprising at least one indicator, said indicator being disposed within and visible from said contact surface.

7. The user interface according to claim 6, wherein said indicator informs the user of a status of a network connection.

8. The user interface according to claim 6, wherein said indicator informs the user of the receipt of an incoming communications signal.

9. The user interface according to claim 1, wherein the flexible cover includes a designation associated with a customer.

10. A method of assembling a mobile communications unit, comprising the steps of:
producing a universal base component at an assembly facility;
shipping the universal base component to a separate facility, wherein the separate facility contains a selection of user interfaces, wherein the user interfaces are used to initiate a feature in the mobile communications unit and wherein the selection of user interfaces includes user interfaces associated with different customers;
selecting a user interface from the selection of user interfaces; and
at the separate facility, incorporating the selected user interface into the universal base component.

11. The method according to claim 10, wherein the user interface includes a flexible cover and a flexible sheet, wherein the flexible cover includes at least one extension extending away from the flexible cover and the flexible sheet includes at least one corresponding extension extending away from the flexible sheet.

12. The method according to claim 11, wherein said incorporating step comprises the step of manipulating the user interface to permit the extensions of the flexible cover and the extensions of the flexible sheet to engage at least one slot positioned on the universal base component.

13. The method according to claim 12, wherein said incorporating step further comprises the step of positioning the flexible sheet adjacent to the flexible cover, whereby the flexible sheet at least partially directs the flexible cover in a manner that permits the extensions of the flexible cover to engage the slots.

14. The method according to claim 10, wherein each of the user interfaces includes a designation identifying the user interface as being associated with a customer.
